(19) United States
(12) Patent Application Publication
(10) Pub. No.: US 2024/0016148 A1
(43) Pub. Date: Jan. 18, 2024

(54) METHODS FOR POTENTIATING A BIOCIDE

(71) Applicant: The Procter & Gamble Company, Cincinnati, OH (US)

(72) Inventors: Sherri Lynn RANDALL, Hamilton, OH (US); Jonathan Harris Flannery, Cincinnati, OH (US); Jeffrey Van Komen, Wilmington, OH (US)

(21) Appl. No.: 17/749,312

(22) Filed: May 20, 2022

(51) Int. Cl. A01N 33/12; A01N 25/30; A01P 1/00

(52) U.S. Cl. CPC A01N 33/12; A01P 1/00; A01N 25/30

(57) ABSTRACT

A method of potentiating a biocidal impact of a dialkyl dimethyl quaternary ammonium salt, can include forming a composition by combining about 8% to about 20%, by weight of the composition, of a propoxylated and ethoxylated nonionic surfactant having an average carbon chain length of about 6 to about 10, or about 3% to about 20% by weight of the composition of an amine oxide; and about 1% to about 3%, by weight of the composition, of the dialkyl dimethyl quaternary ammonium salt.

### FIELD OF THE INVENTION

Methods for potentiating a biocide can include combining the biocide with a potentiator.

### BACKGROUND OF THE INVENTION

Biocides are commonly used in household products to help combat pathogens which have entered the home. These household products can include, for example, hard surface cleaners, fabric care compositions, dish care compositions, etc. Formulating with biocides, however, can be tricky as other ingredients can impede the biocides. In addition, it is desirable to use only the minimum amount of biocide necessary for the desired task. Thus, it is beneficial to find and utilize ingredients in a household product, for example, which do not impede the desired biocide. As such, there is a need for ingredients which are suitable for formulation with a biocide.

### SUMMARY OF THE INVENTION

Included herein, for example, is a method of potentiating a biocidal impact of a dialkyl dimethyl quaternary ammonium salt, comprising forming a composition by combining about 8% to about 20%, by weight of the composition, of a propoxylated and ethoxylated nonionic surfactant comprising an average carbon chain length of about 6 to about 10, and about 1% to about 3%, by weight of the composition, of the dialkyl dimethyl quaternary ammonium salt, wherein the composition has a higher biocidal impact on Staphylococcus aureus, Klebsiella pneumoniae, Escherichia coli, or any combination thereof, than the sum of the biocidal impact of the dialkyl dimethyl quaternary ammonium salt and the nonionic surfactant on the Staphylococcus aureus, Klebsiella pneumoniae, Escherichia coli, or any combination thereof.

Also included herein, for example, is a method of potentiating a biocidal impact of a dialkyl dimethyl quaternary ammonium salt, comprising forming a composition by combining about 3% to about 20%, by weight of the composition, of an amine oxide, and about 1% to about 3%, by weight of the composition, of the dialkyl dimethyl quaternary ammonium salt, wherein the composition has a higher biocidal impact on Staphylococcus aureus than the sum of the biocidal impact of the dialkyl dimethyl quaternary ammonium salt and the amine oxide on the Staphylococcus aureus.

These and other incarnations will be more fully described throughout the specification.

### DETAILED DESCRIPTION OF THE INVENTION

For consumer product companies, there is an opportunity to help consumers who are interested in products which can effectively reduce and/or eliminate certain bacteria. Actives which can help reduce and/or eliminate bacteria are known as biocides. While biocides in general have long been used for their antimicrobial properties, certain biocides can be difficult to formulate in a way that maintains their potency.

While there are materials and conditions that can be detrimental to the efficacy of a biocide, there are also conditions and materials which can enhance the efficacy of a biocide. Materials which perform this task are known are potentiators. Potentiators can be extremely beneficial in a formulation as they may allow for the use of a lower level of biocide which can decrease cost.

A potentiator is a material that may demonstrate an improvement to the biocidal effect of the target biocide on the target organism. To evaluate whether a material has a potentiation effect, the level of any biocidal activity of the potential potentiator and the target biocide are measured. In order to be determined to be a potentiator, more than an additive effect needs to be seen (i.e. the biocidal impact of the combination needs to be higher than that of the sum of the biocide and the potential potentiator). It is expected a potentiator will have minimal, if any, biocidal effect on its own.

Some materials are evaluated to determine whether they could potentiate a dialkyl dimethyl quaternary ammonium salt biocide, for example Bardac® from Lonza. This biocide is a combination of three active ingredients: octyl decyl dimethyl ammonium chloride, dioctyl dimethyl ammonium chloride, and didecyl dimethyl ammonium chloride in a ratio by weight of 2.5:1.0:1.5. Among the materials included in the review are a nonionic branched C8 propoxylated and ethoxylated surfactant (Ecosurf™ EH-9 from Dow®, Inc.) and a C10-C16 alkyl dimethyl amine oxide. Interestingly, both of these materials show a potentiating effect toward a dialkyl dimethyl quaternary ammonium salt biocide.

As can be seen in Table 1, below, the nonionic surfactant shows a potentiating effect on the biocide at active levels of 1.5% and 2.5% of the biocide increasing its impact well above the additive value of the two materials separately. Moreover, this effect was seen on both bacteria tested, Staphylococcus aureus and Klebsiella pneumoniae, and in both scenarios tested. ASTM E2406-16 is used and evaluates the sanitizing effects of materials used in high efficiency automatic clothes washing machines. This test method can look at the sanitizing effect in the wash water after a simulated wash cycle (“water”) and on a fabric that has been run through a simulated wash cycle (“fabric”), described in more detail in the method.

TABLE 1

| | Lower | Higher | | | Combination | Combination |
|---|---|---|---|---|---|---|
| | Bardac ® | Bardac ® | Ecosurf ™ | Ecosurf ™ | Lower | Higher |
| | 2080 | 2080 | EH-9 | EH-9 | Bardac ® and | Bardac ® and |
| | Alone | Alone | Alone (1) | Alone (2) | Ecosurf ™ (2) | Ecosurf ™ (1) |
| Bardac® 2080 | 1.5% | 2.5% | — | — | 1.5% | 2.5% |
| (active wt %) | | | | | | |
| Ecosurf ™ EH-9 | — | — | 14% | 14% | 14% | 14% |
| (active wt %) | | | | | | |
| triethanolamine | 0.4% | 0.4% | 0.4% | 0.4% | 0.4% | 0.4% |
| (active wt %) | | | | | | |
| thickener | 3.0% | 3.0% | 3.0% | 3.0% | 3.0% | 3.0% |
| (Antil 127 MB) | | | | | | |
| (“as added” wt %) | | | | | | |
| Dye | 0.0075% | 0.0075% | 0.0075% | 0.0075% | 0.0075% | 0.0075% |
| (“as added” wt %) | | | | | | |
| Perfume | 0.5% | 0.5% | 0.5% | 0.5% | 0.5% | 0.5% |
| (“as added” wt %) | | | | | | |
| Water | to 100% | to 100% | to 100% | to 100% | to 100% | to 100% |
| pH | ~8.9 | ~8.9 | ~8.9 | ~8.9 | ~8.9 | ~8.9 |
| AB TEST | | | | | | |
| Staphylococcus | 0.12 | 1.1 | −0.1 | 0.00 | 1.15 | 2.80 |
| aureus on fabric | | | | | | |
| Staphylococcus | 0.19 | 1.9 | −0.1 | −0.20 | 2.29 | 4.10 |
| aureus in water | | | | | | |
| Klebsiella | 1.26 | 1.1 | 0.6 | 0.70 | 3.51 | 3.00 |
| pneumoniae on | | | | | | |
| fabric | | | | | | |
| Klebsiella | 0.90 | 1.2 | 0.7 | 0.80 | 3.62 | 2.90 |
| pneumoniae in water | | | | | | |

In addition, amine oxide is evaluated as a potential potentiator of the dialkyl dimethyl quaternary ammonium salt biocide. Table 2 includes results from this evaluation. As can be seen in Table 2, the amine oxide (at 14 active wt %) shows a potentiating effect on the biocide at an active level of 1.8% of the biocide increasing its impact well above the additive value of the two materials separately. This impact is seen on Staphylococcus aureus in both scenarios tested (fabric and water). In addition, there appears to be a synergy between the nonionic surfactant, amine oxide, and the dialkyl dimethyl quaternary ammonium salt biocide on Staphylococcus aureus in both scenarios tested (fabric and water).

TABLE 2

| | | | | Combo | Combo | Combo | Combo |
|---|---|---|---|---|---|---|---|
| | | | Lower | Bardac ® | Bardac ® | Bardac ®, | Bardac ®, |
| | Bardac ® | Ecosurf ™ | Amine | and Lower | and Higher | Lower Amine | Higher Amine |
| | 2080 | EH- | Oxide | Amine | Amine | Oxide, | Oxide, |
| | Alone | 9 Alone | Alone | Oxide | Oxide | Ecosurf ™ | Ecosurf ™ |
| Bardac ® 2080 | 1.8% | — | — | 1.8% | 1.8% | 1.8% | 1.8% |
| (active wt %) | | | | | | | |
| Ecosurf ™ EH- | — | 14% | — | — | — | 14% | 14% |
| 9 (active wt %) | | | | | | | |
| Amine Oxide | — | — | 14% | 14% | 25.6% | 14% | 21.12% |
| (active wt %) | | | | | | | |
| Detergent base | to 100% | to | to | to 100% | to 100% | to 100% | to 100% |
| (builder, chelant, | | 100% | 100% | | | | |
| enzyme, water, | | | | | | | |
| etc.) | | | | | | | |
| AB TEST | | | | | | | |
| Staphylococcus | −0.03 | 0.42 | 0.11 | 3.45 | 3.48 | 3.19 | 3.21 |
| aureus on fabric | | | | | | | |
| Staphylococcus | 0.19 | 0.12 | 0.22 | 3.35 | 3.59 | 1.81 | 3.29 |
| aureus in water | | | | | | | |

### Methods for Potentiating a Biocide

In light of the above, included herein are methods for potentiating a biocidal impact of a dialkyl dimethyl quaternary ammonium salt biocide. The method may include, for example, forming a composition by combining a dialkyl dimethyl quaternary ammonium salt biocide with a potentiator.

The dialkyl dimethyl quaternary ammonium salt biocide may be present in an amount of about 1% to about 5%, by weight of the composition. Additionally, the dialkyl dimethyl quaternary ammonium salt biocide may be present at an active level of about 1% to about 4%, about 1% to about 3.5%, about 1% to about 3%, about 1.25% to about 2.75%, about 1.5% to about 2.5%, or about 1.8%, by weight of the composition. The dialkyl dimethyl quaternary ammonium salt biocide may include an anion. The anion may comprise, for example, chloride, bromide, acetate, borate, propionate, carbonate, bicarbonate, hydroxide, or a combination thereof. The anion may be a halide. The halide can include bromide and/or chloride.

The dialkyl dimethyl quaternary ammonium salt biocide may comprise di-n-decyldimethylammonium chloride, dioctyldimethylammonium chloride, octyl decyl dimethylammonium chloride, di-n-decyldimethylammonium bromide, dioctyldimethylammonium bromide, octyl decyl dimethylammonium bromide, or a combination thereof. The dialkyl dimethyl quaternary ammonium salt biocide may be a combination of octyl decyl dimethyl ammonium chloride, dioctyl dimethyl ammonium chloride, and didecyl dimethyl ammonium chloride. The combination of octyl decyl dimethyl ammonium chloride, dioctyl dimethyl ammonium chloride, and didecyl dimethyl ammonium chloride may have a ratio by weight of about 2.5 (octyl decyl dimethyl ammonium chloride):about 1.0 (dioctyl dimethyl ammonium chloride):about 1.5 (didecyl dimethyl ammonium chloride). The dialkyl dimethyl quaternary ammonium salt biocide may be Bardac® 2050 and/or Bardac® 2080 available from Arxada, Inc (previously dba Lonza, Inc.).

A potentiator may include, for example, a propoxylated and ethoxylated nonionic surfactant, an amine oxide, or a combination thereof. A potentiator may be present at a level of about 5% to about 30%, about 7% to about 28%, or from about 8% to about 28%, by weight of the composition.

A potentiator may include, for example a propoxylated and ethoxylated nonionic surfactant. The propoxylated and ethoxylated nonionic surfactant may have an average carbon chain length of about 6 to about 10. The propoxylated and ethoxylated nonionic surfactant may have an average carbon chain length of about 6 to about 10, about 6 to about 9, about 7 to about 8, or about 8. The carbon chain may be linear or branched. The propoxylated and ethoxylated nonionic surfactant may comprise a 2-ethyl hexanol propoxylated ethoxylated surfactant. The propoxylated and ethoxylated nonionic surfactant may have an average level of ethoxylation of about 6 to about 10, about 7 to about 9, about 8 to about 9, or about 9. The propoxylated and ethoxylated nonionic surfactant may have an average level of propoxylation of about 3 to about 7, about 4 to about 7, about 4 to about 6, about 5 to about 6, or about 5.

The propoxylated and ethoxylated nonionic surfactant can be present at an active level of about 8% to about 25%, from about 8% to about 20%, from about 10% to about 20%, from about 12% to about 18%, from about 12% to about 16%, from about 13% to about 15%, or about 14%. The propoxylated and ethoxylated surfactant may be present at a ratio by weight to the dialkyl dimethyl quaternary ammonium salt biocide of about 3:1 to about 20:1 or about 5:1 to about 10:1.

A potentiator may also include amine oxide. The amine oxide may include for example, a C10-C16 alkyl dimethyl amine oxide, an amido propyl dimethyl amine oxide, or a combination thereof. The amine oxide may be present at an active level of about 3% to about 30%, from about 3% to about 25%, from about 3% to about 25%, from about 5% to about 25%, from about 7% to about 25%, from about 7% to about 20%, from about 7% to about 14%, from about 12% to about 28%, from about 13% to about 26%, from about 13% to about 15%, from about 20% to about 26%, from about 5% to about 9%, from about 12% to about 16%, about 14%, about 21%, or about 25.5% by weight of the composition.

The amine oxide may comprise a coco dimethyl amine oxide. An amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The amine oxide may include alkylamidopropylamine oxide, wherein an amidopropyl group is inserted between the R1 and N of the prior formula, for example:

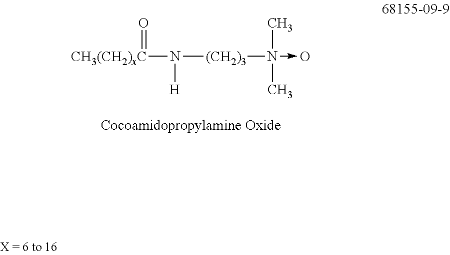

The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, linear C12-C14 alkyl dimethyl amine oxides, and C10-C16 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide.

Some examples of combinations of materials and levels of a potentiator of a dialkyl dimethyl quaternary ammonium salt biocide may be seen in Table 3, below.

TABLE 3

| | dialkyl dimethyl | ethoxylated and | |
|---|---|---|---|
| | quaternary ammonium | propoxylated | C10-C16 alkyl |
| | salt biocide | nonionic surfactant | dimethyl amine |
| | (Bardac ® 2080) | (Ecosurf ™ EH-9) | oxide |
| Example 1 | 1.8% | — | 14% |
| Example 2 | 1.8% | 14% | 14% |
| Example 3 | 1.8% | 14% | 21.12% |
| Example 4 | 1.8% | — | 25.6% |
| Example 5 | 1.8% | 14% | — |
| Example 6 | 2.5% | 14% | — |
| Example 7 | 1.5% | 14% | — |
| Example 8 | 1.8% | 14% | 7% |

In addition to a dialkyl dimethyl quaternary ammonium biocide and a potentiator, a composition may also include, for example, an additional nonionic surfactant. An additional non-ionic surfactant may include, for example, an ethoxylated alcohol. A composition may comprise from about 1%, 2%, 3%, 4%, 5%, 6%, 7%, 8%, or 9%, to about 2%, 3%, 4%, 5%, 6%, 7%, 8%, 9%, or 10% or any combination thereof, by weight of the composition of a nonionic ethoxylated alcohol.

The additional nonionic surfactant may have the formula R(OC₂H₄)ₙOH, wherein R is selected from the group consisting of aliphatic hydrocarbon radicals containing from about 8 to about 16 carbon atoms and can be linear or branched and the average value of n is from about 5 to about 15. For example, the additional nonionic surfactant may be selected from ethoxylated alcohols having an average of about 12-14 carbon atoms in the alcohol (alkyl) portion and an average degree of ethoxylation of about 7-9 moles of ethylene oxide per mole of alcohol.

Additional non limiting examples include ethoxylated alkyl phenols of the formula R(OC₂H₄)ₙOH, wherein R comprises an alkyl phenyl radicals in which the alkyl groups contain from about 8 to about 12 carbon atoms, and the average value of n is from about 5 to about 15, C₁₂-C₁₈ alkyl ethoxylates, such as, NEODOL® nonionic surfactants from Shell; C₁₄-C₂₂ mid-chain branched alcohols; C₁₄-C₂₂ mid-chain branched alkyl ethoxylates, BAEₓ, wherein x is from 1 to 30. The nonionic ethoxylated alcohol surfactant herein may further comprise residual alkoxylation catalyst, which may be considered residue from the reaction or an impurity. It may further comprise various impurities or by-products of the alkoxylation reaction. The impurities may vary depending on the catalyst used and the conditions of the reaction. Impurities include alkyl ethers, e.g., dialkyl ethers, such as, didodecyl ether, glycols, e.g., diethylene glycol, triethylene glycol, pentaethylene glycol, other polyethylene glycols.

The nonionic ethoxylated alcohol may be a narrow range ethoxylated alcohol. A narrow range ethoxylated alcohol may have the following general formula (I):

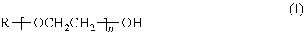

where R is selected from a saturated or unsaturated, linear or branched, C₈-C₂₀ alkyl group and where greater than 90% of n is 0≤n≤15. In addition, the average value of n can be between about 4 to about 14, preferably about 6 to about 10, where less than about 10% by weight of the alcohol ethoxylate are ethoxylates having n<7 and between 10% and about 20% by weight of the alcohol ethoxylate are ethoxylates having n=8.

The composition may comprise an average value of n of about 10. The composition may have the following ranges for each of the following n: n=0 of up to 5%, each of n=1, 2, 3, 4, 5 of up to 2%, n=6 of up to 4%, n=7 of up to 10%, n=8 of between 12% and 20%, n=9 of between 15% and 25%, n=10 of between 15% to 30%, n=11 of between 10% and 20%, n=12 of up to 10%, and n>12 at up to 10%. The composition may have n=9 to 10 of between 30% and 70%. The composition may have greater than 50% of its composition made up of n=8 to 11.

R can be selected from a saturated or unsaturated, linear or branched, C12-C16 alkyl group, where the average value of n is between about 6 and about 10. R can also be selected from a saturated or unsaturated, linear or branched, C8-C20 alkyl group, where greater than 90% of n is 0≤n≤15, and where the average value of n between about 5 to about 10, where less than about 20% by weight of the alcohol ethoxylate are ethoxylates having n<8. R can also be selected from a saturated or unsaturated, linear or branched, C₈-C₂₀ alkyl group, where greater than 90% of n is 0≤n≤15, and where the average value of n between about 6 to about 10, where less than about 10% by weight of the alcohol ethoxylate are ethoxylates having n<7 and between 10% and about 20% by weight of the alcohol ethoxylate are ethoxylates having n=8.

The alcohol ethoxylates described herein are typically not single compounds as suggested by their general formula (I), but rather, they comprise a mixture of several homologs having varied polyalkylene oxide chain length and molecular weight. Among the homologs, those with the number of total alkylene oxide units per mole of alcohol closer to the most prevalent alkylene oxide adduct are desirable; homologs whose number of total alkylene oxide units is much lower or much higher than the most prevalent alkylene oxide adduct are less desirable. In other words, a “narrow range” or “peaked” alkoxylated alcohol composition is desirable. A “narrow range” or “peaked” alkoxylated alcohol composition refers to an alkoxylated alcohol composition having a narrow distribution of alkylene oxide addition moles.

A “narrow range” or “peaked” alkoxylated alcohol composition may be desirable for a selected application. Homologs in the selected target distribution range may have the proper lipophilic-hydrophilic balance for a selected application. For example, in the case of an ethoxylated alcohol product comprising an average ratio of 5 ethylene oxide (EO) units per molecule, homologs having a desired lipophilic-hydrophilic balance may range from 2EO to 9EO. Homologs with shorter EO chain length (<2EO) or longer EO chain length (>9EO) may not be desirable for the applications for which a=5 EO/alcohol ratio surfactant is ordinarily selected since such longer and shorter homologs are either too lipophilic or too hydrophilic for the applications utilizing this product. Therefore, it is advantageous to develop an alkoxylated alcohol having a peaked distribution.

The narrow range alkoxylated alcohol compositions of the disclosure may have an average degree of ethoxylation ranging from about 0 to about 15, such as, for example, ranging from about 4 to about 14, from about 5-10, from about 8-11, and from about 6-9. The narrow range alkoxylated alcohol compositions of the disclosure may have an average degree of ethoxylation of 10. The narrow range alkoxylated alcohol compositions of the disclosure may have an average degree of ethoxylation of 9. The narrow range alkoxylated alcohol compositions of the disclosure may have an average degree of ethoxylation of 5.

The ranges described above are exemplified in Table A in the Novel 1214-9 column. As shown below in Table A, samples were analyzed by LCMS ESI (−) after derivatization with DMF-SO₃ complex as well as by LCMS ESI (+). % Relative abundances are listed below in the table. Percent Relative Abundance is the weighted average of each ethoxymer relative to the total abundance of all ethoxymers in the sample.

TABLE A

| Moles of EO | Alfonic 1214-9 | Novel 1214-9 |
|---|---|---|
| 0 | 3.14% | 2.33% |
| 1 | 1.26% | 0% |
| 2 | 1.55% | 0% |
| 3 | 2.20% | 0% |
| 4 | 3.08% | 0.39% |
| 5 | 4% | 0.940% |
| 6 | 5.21% | 2.93% |
| 7 | 6.58% | 7.90% |
| 8 | 8.10% | 15.96% |
| 9 | 9.41% | 21.56% |
| 10 | 9.78% | 21.27% |
| 11 | 9.51% | 15.19% |
| 12 | 8.58% | 7.64% |
| 13 | 7.35% | 2.84% |
| 14 | 5.98% | 0.88% |
| 15 | 4.65% | 0.18% |
| 16 | 3.46% | 0% |
| 17 | 2.48% | 0% |
| 18 | 1.74% | 0% |
| 19 | 1.17% | 0% |
| 20 | 0.75% | 0% |

Please note that LCMS-ESI (+) is not sensitive to ethoxymers of less than 3 moles, nor free alcohol. In addition, ethoxymers between 3-5 moles are underrepresented. Typically, if the average distribution of EO is greater than 7 moles of EO, the distribution is not greatly affected by this limit of sensitivity. Additionally, LCMS-ESI (−) can underrepresent heavier ethoxymers when the distribution is very wide, as in ALFONIC samples. For this reason, the ALFONIC sample was analyzed in both+/−modes and the average was taken.

The composition may also be substantially free of or free of additional nonionic surfactants. Substantially free of means about 1% or less, while free of means the material is not deliberately added.

The composition may further include an amphoteric surfactant and/or zwitterionic surfactant. The composition may include from about 0.1% to about 15%, about 0.1% to about 10%, about 0.2% to about 10%, about 0.5% to about 10%, from about 1% to about 8%, from about 1% to about 5%, by weight of the composition of an amphoteric and/or zwitterionic surfactant. Suitable amphoteric and/or zwitterionic surfactants can include betaines, such as alkyl betaines, alkylamidobetaine, amidazoliniumbetaine, sulfobetaine (INCI Sultaines), as well as phosphobetaines, or combinations thereof.

The method may further include adding a detergent adjunct to a composition. One or more adjunct ingredients can be included in a composition at a level by weight, for example, of about 0.1% to about 50%. Adjunct ingredients can include, for example, color care agents; organic solvents; aesthetic dyes; hueing dyes; leuco dyes; opacifiers such as those commercially available under the Acusol tradename, brighteners including FWA49, FWA15, and FWA36; dye transfer inhibitors including PVNO, PVP and PVPVI dye transfer inhibitors; builders including, for example, citric acid; chelants; enzymes; perfume, perfume capsules; preservatives; antioxidants including sulfite salts such as potassium sulphite or potassium bisulphite salts and those commercially available under the Ralox brand name; antibacterial and anti-viral agents including 4.4′-dichloro 2-hydroxydiphenyl ether such as Tinosan HP100 available from the BASF company; anti-mite actives such as benzyl benzoate; structuring agents including hydrogenated castor oil; silicone based anti-foam materials; electrolytes including inorganic electrolytes such as sodium chloride, potassium chloride, magnesium chloride, and calcium chloride, and related sodium, potassium, magnesium and calcium sulphate salts, as well as organic electrolytes such as sodium, potassium, magnesium and calcium salts of carbonate, bicarbonate, carboxylates such as formate, citrate and acetate; borates, such as borax or sodium tetra borate; pH trimming agents including sodium hydroxide, hydrogen chloride, sulfuric acid, and alkanolamines including monoethanolamine, diethanolamine, triethanolamine, and monoisopropanolamine; a probiotic; a hygiene agent such as zinc ricinoleate, thymol, quaternary ammonium salts such as Bardac®, polyethylenimines (such as Lupasol® from BASF) and zinc complexes thereof, silver and silver compounds, a cationic biocide including octyl decyl dimethyl ammonium chloride, dioctyl dimethyl ammonium chloride, didecyl dimethyl ammonium chloride, dispersant, cleaning polymer, glucan, or a mixture thereof. For example, the detergent adjunct comprises an enzyme, an enzyme stabilizer, a builder, a hueing agent, soil release polymer, anti-soil redeposition agent, a bleach, or a combination thereof.

The organic solvent can include an alcohol and/or a polyol. For example, the organic solvent can comprise ethanol, propanol, isopropanol, a sugar alcohol, a glycol, a glycol ether, glycerin, or a combination thereof. The organic solvent can comprise polyethylene glycol, especially low molecular weight polyethylene glycols such as PEG 200 and PEG 400; diethylene glycol; glycerol; 1,2-propanediol; polypropylene glycol including dipropylene glycol and tripropylene glycol and low molecular weight polypropylene glycols such as PPG400; or a mixture thereof.

The chelant can comprise, for example, EDDS, HEDP, GLDA, DTPA, DTPMP, DETA, EDTA, MGDA, Disodium 4,5-dihydroxybenzene-1,3-disulfonate [Tiron] or a mixture thereof. The chelant can be biodegradable. Biodegradable chelants can include, for example, GLDA, NTA, IDS, EDDG, EDDM, HIDS, HEIDA, HEDTA, DETA, or a combination thereof.

The enzyme can comprise, for example, protease, amylase, cellulase, mannanase, lipase, xyloglucanase, pectate lyase, nuclease enzyme, phosphodiesterase, or a mixture thereof.

Cleaning polymers can include, for example, those which can help clean stains or soils on clothing and/or help prevent those soils from redepositing on clothing during the wash. Examples are optionally modified polyglucans, poly(vinyl-pyrrolidone), poly (ethylene glycol), poly(vinyl alcohol), poly(vinylpyridine-N-oxide), poly(vinylimidazole), or a combination thereof.

The composition may comprise one or more amphiphilic cleaning polymers. Such polymers have balanced hydrophilic and hydrophobic properties such that they remove grease particles from fabrics and surfaces. Suitable amphiphilic alkoxylated grease cleaning polymers comprise a core structure and a plurality of alkoxylate groups attached to that core structure. These may comprise alkoxylated polyalkylenimines, especially ethoxylated polyethylene imines or polyethyleneimines having an inner polyethylene oxide block and an outer polypropylene oxide block. Typically, these may be incorporated into the compositions of the invention in amounts of from 0.005 to 10 wt %, generally from 0.5 to 8 wt %.

The composition may comprise, for example, a thickener. The composition may include from about 0.1% to about 10%, from about 0.5% to about 9%, from about 1% to about 8%, from about 1% to about 7%, from about 1% to about 6%, from about 1% to about 5%, from about 1% to about 4%, from about 2% to about 4%, by weight of the composition of a thickener. The thickener may include, for example, a PEG-120 methyl glucose dioleate, PEG-120 methyl glucose trioleate, or a combination thereof. Commercial thickeners can include, for example, Antil® 127 MB available from Evonik, Glucamate™ LT and Glucamate™ VLT available from Lubrizol.

### Water

The composition may also include water. Water can be present, for example, at a level of about 5% to about 95%, by weight of the composition. The water may be included at a level of about 10% to about 90%. In addition, the composition can include from about 25% to about 90%, from about 30% to about 90%, from about 40% to about 90%, from about 50% to about 90%, from about 60% to about 90%, from about 70% to about 90%, or from about 75% to about 90%, by weight of the composition of water.

pH

The composition may have a pH of about 5.0 to about 12, preferably 6.0-10.0, more preferably from 8.0 to 10. wherein the pH of the composition is measured as a 10% dilution in demineralized water at 20° C.

### Viscosity

A composition can be in the form of an aqueous solution or uniform dispersion or suspension, for example. Such a solution, dispersion or suspension will be acceptably phase stable. The composition may be a detergent composition or a rinse additive.

A liquid detergent composition can have a viscosity from 1 to 1500 centipoises (1-1500 mPa*s), more preferably from 100 to 1000 centipoises (100-1000 mPa*s), and most preferably from 200 to 500 centipoises (200-500 mPa*s) at 20 s-1 and 21° C. Viscosity can be determined by conventional methods. Viscosity may be measured using an AR 550 rheometer from TA instruments using a plate steel spindle at 40 mm diameter and a gap size of 500 μm. The high shear viscosity at 20 s-1 and low shear viscosity at 0.05-1 can be obtained from a logarithmic shear rate sweep from 0.1-1 to 25-1 in 3 minutes time at 21° C. The preferred rheology described therein may be achieved using internal existing structuring with detergent ingredients and/or by employing an external rheology modifier. More preferably the laundry care compositions, such as detergent liquid compositions have a high shear rate viscosity of from about 50 centipoise to 1500 centipoise, more preferably from 100 to 1000 cps.

A rinse additive can have a viscosity of about 1 to 1500 centipoises (1-1500 mPa*s), more preferably from 50 to 1000 centipoises (100-1000 mPa*s), and most preferably from 50 to 500 centipoise (100-500 mPa*s) at 20 s-1 and 21° C. Viscosity can be determined by conventional methods. Viscosity may be measured using an AR 550 rheometer from TA instruments using a plate steel spindle at 40 mm diameter and a gap size of 500 μm.

### Composition Making

The liquid compositions can be prepared, for example, by combining the components thereof in any convenient order and by mixing, e.g., agitating, the resulting component combination to form a phase stable liquid laundry composition. In a process for preparing such compositions, a liquid matrix can be formed containing at least a major proportion, or even substantially all, of the liquid components, e.g., nonionic surfactant, the non-surface-active liquid carriers and other optional liquid components, with the liquid components being thoroughly admixed by imparting shear agitation to this liquid combination. For example, rapid stirring with a mechanical stirrer may usefully be employed. While shear agitation is maintained, substantially all surfactants and the solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles or solutions of any enzyme material to be included are incorporated. As a variation of the composition preparation procedure hereinbefore described, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period from about 30 to minutes.

### Example Laundry Compositions

### Inventive Laundry Detergent Compositions

| | Comp. 1 | Comp. 2 | Comp. 3 | Comp. 4 | Comp. 5 | Comp. 6 | Comp. 7 |
|---|---|---|---|---|---|---|---|
| Bardac 2080 | 2.63 | 1.50 | 2.50 | 1.80 | 1.80 | 1.80 | 1.80 |
| Ecosurf EH9 | 14.00 | 14.00 | 14.00 | 14.00 | — | 14.00 | 14.00 |
| Triethanolamine | 0.40 | 0.40 | 0.40 | 0.40 | 0.40 | 0.40 | 0.40 |
| Antil 127 | 3.00 | 3.00 | 3.00 | 3.00 | 3.00 | 3.00 | — |
| perfume | 0.50 | 0.50 | 0.50 | 0.50 | 0.50 | 0.50 | 0.50 |
| Dye | 0.0075 | 0.0075 | 0.0075 | 0.0075 | 0.0075 | 0.0075 | 0.0075 |
| C10-C16 alkyl | — | — | — | — | 14.00 | 14.00 | 7.00 |
| dimethyl amine | | | | | | | |
| oxide | | | | | | | |
| Water | to 100 | to 100 | to 100 | to 100 | to 100 | to 100 | to 100 |
| pH | ~8.9 | ~8.9 | ~8.9 | ~8.9 | ~8.9 | ~8.9 | ~8.9 |

The above inventive laundry detergent formulations and the below listed laundry rinse formulations may be prepared by the composition method of making listed above. As can be seen from the compositions, some of the detergent formulations are also listed as rinse formulations as these are suitable for use either as a detergent or a rinse.

### Inventive Laundry Rinse Formulations

| | Rinse Comp. 1 | Rinse Comp. 2 |
|---|---|---|
| Bardac 2080 | 2.63 | 2.50 |
| Ecosurf EH9 | 14.00 | 14.00 |
| Triethanolamine | 0.40 | 0.40 |
| Antil 127 | 3.00 | 3.00 |
| perfume | 0.50 | 0.50 |
| Dye | 0.0075 | 0.0075 |
| C10-C16 alkyl | — | — |
| dimethyl amine | | |
| oxide | | |
| Water | To 100 | to 100 |
| pH | ~8.9 | ~8.9 |

### Method to Determine Potentiation

A material is considered to be a potentiator if the bacterial log reduction of a formula containing the combination of the material and the biocide provides a larger bacterial log reduction than the sum of the result obtained for a formula containing the material without biocide plus the result obtained for a formula for the biocide without the material. This is represented by the following equation:

Log R(potentiator+biocide formula)>[log R(potentiator formula)+log R(biocide formula)]

For example, a target material, like a propoxylated and ethoxylated nonionic surfactant, and the biocide of interest, like a dialkyl dimethyl quaternary ammonium salt, would be formulated into a composition (potentiator+biocide formula); the target material would be formulated into the same composition as the potentiator/biocide combination replacing the biocide with water (potentiator formula); and the biocide would be formulated into the same composition as the potentiator/biocide combination replacing the target material with water (biocide formula). Some example laundry compositions are included above as examples of potentiator+biocide formulas.

To measure the log reduction and do the calculation noted above, the potential potentiator material can be tested along with the target biocide in accordance with ASTM E2406-16. As described in the method, the biocidal impact may be measured on a fabric and/or on the wash water of a simulated wash cycle where the laundry composition is added during the wash cycle as described in ASTM E2406-16. The method leaves the water:fabric ratio undefined. Here, the water:fabric ratio may be about 2.5:1 by weight. The wash water can be at a temperature of about 20° C. The laundry composition can be dosed at 150 mL/19 L of water in the wash cycle. The wash cycle time can be about 15 minutes.

In addition to this, the method can be adapted for use in a rinse cycle, to allow for the measurement of biocidal impact on the rinse water and/or rinsed fabric for a laundry composition adapted to be added during the rinse. This is done by making the laundry compositions as discussed above and adding them during the rinse cycle instead of a wash cycle. The rinse water is at a temperature of about 20° C. The laundry composition is dosed at 150 mL/19 L of rinse water. The water:fabric ratio may be about 2.5:1 by weight. The rinse cycle time is about 15 minutes. One other difference between measurements utilizing the wash and rinse cycles is that 5% of BSA is mixed with the bacteria when it is applied to fabric to be utilized in a wash condition, but only water is used for rinse conditions.

Moreover, a target bacteria needs to be selected for which the potential potentiation will be reviewed. Examples of bacteria that can be utilized in this method include Staphylococcus aureus, Klebsiella pneumoniae, Escherichia coli, or a combination thereof. In looking at potentiation, a potentiator can have an impact on a biocide with respect to one bacteria and not others, so lack of a potentiating effect with a biocide on one bacteria is not necessarily prophetic on all bacteria.

Additionally biocidal impact may be measured on a hard surface. This is done in accordance with ASTM e1153.

### “Combinations:”

A) A method of potentiating a biocidal impact of a dialkyl dimethyl quaternary ammonium salt, comprising forming a composition by combining 8% to 20%, by weight of the composition, of a propoxylated and ethoxylated nonionic surfactant comprising an average carbon chain length of about 6 to about 10, and 1% to 3%, by weight of the composition, of the dialkyl dimethyl quaternary ammonium salt, wherein the composition has a higher biocidal impact on Staphylococcus aureus, Klebsiella pneumoniae, Escherichia coli, or any combination thereof, than the sum of the biocidal impact of the dialkyl dimethyl quaternary ammonium salt and the nonionic surfactant on the Staphylococcus aureus, Klebsiella pneumoniae, Escherichia coli, or any combination thereof.

B) The method of paragraph A, wherein the dialkyl dimethyl quaternary ammonium salt comprises an anion comprising chloride, bromide, acetate, borate, propionate, carbonate, bicarbonate, hydroxide, or a combination thereof.

C) The method of paragraph B, wherein the anion comprises bromide or chloride.

D) The method of any of paragraphs A-C, wherein the biocidal impact is measured on Staphylococcus aureus, Klebsiella pneumoniae, or Escherichia coli, preferably Staphylococcus aureus or Klebsiella pneumoniae.

E) The method of any of paragraphs A-D, wherein the dialkyl dimethyl quaternary ammonium salt comprises di-n-decyldimethylammonium chloride, dioctyldimethylammonium chloride, octyl decyl dimethylammonium chloride, di-n-decyldimethylammonium bromide, dioctyldimethylammonium bromide, octyl decyl dimethylammonium bromide, or a combination thereof; preferably a combination of di-n-decyldimethylammonium chloride, dioctyldimethylammonium chloride, and octyl decyl dimethylammonium chloride.

F) The method of any of paragraphs A-E, wherein the ethoxylated and propoxylated surfactant comprises a 2-ethyl hexanol propoxylated ethoxylated surfactant.

G) The method of any of paragraphs A-F, wherein the biocidal impact is measured on a fabric after a simulated wash cycle or a simulated rinse cycle.

H) The method of any of paragraphs A-G, wherein the biocidal impact is measured on a wash water or a rinse water.

I) The method of any of paragraphs A-F, wherein the biocidal impact is measured on a hard surface, preferably measured in accordance with ASTM e1153.

J) The method of any of paragraphs A-I, wherein the composition is substantially free of additional non-ionic surfactants.

K) The method of any of paragraphs A-J, wherein the ratio by weight of the ethoxylated and propoxylated nonionic surfactant to the dialkyl dimethyl quaternary ammonium salt halide is from 3:1 to 20:1.

L) The method of any of paragraphs A-K, wherein the average level of ethoxylation of the ethoxylated and propoxylated nonionic surfactant is 8 to 9.

M) The method of any of paragraphs A-L, wherein the average level of propoxylation of the ethoxylated and propoxylated nonionic surfactant is 4 to 7.

N) The method of any of paragraphs A-M, wherein the average carbon chain length of the ethoxylated and propoxylated nonionic surfactant is 8 to 10.

O) The method of any of paragraphs A-N, wherein the biocidal impact is measured utilizing ASTM E2406.

P) A method of potentiating a biocidal impact of a dialkyl dimethyl quaternary ammonium salt, comprising forming a composition by combining 3% to 20%, by weight of the composition, of an amine oxide, and 1% to 3%, by weight of the composition, of the dialkyl dimethyl quaternary ammonium salt, wherein the composition has a higher biocidal impact on Staphylococcus aureus than the sum of the biocidal impact of the dialkyl dimethyl quaternary ammonium salt and the amine oxide on the Staphylococcus aureus.

Q) The method of paragraph P, wherein the biocidal impact is measured on a fabric utilizing ASTM E2406.

R) The method of any of paragraphs P-Q, wherein the amine oxide is present is an amount of 5% to 9% or from 12% to 16%, by weight of the composition.

S) The method of any of paragraphs P-R, wherein the dialkyl dimethyl quaternary ammonium salt comprises di-n-decyldimethylammonium chloride, dioctyldimethylammonium chloride, octyl decyl dimethylammonium chloride, di-n-decyldimethylammonium bromide, dioctyldimethylammonium bromide, octyl decyl dimethylammonium bromide, or a combination thereof; preferably a combination of octyl decyl dimethyl ammonium chloride, dioctyl dimethyl ammonium chloride, and didecyl dimethyl ammonium chloride; more preferably octyl decyl dimethyl ammonium chloride, dioctyl dimethyl ammonium chloride, and didecyl dimethyl ammonium chloride with a ratio by weight of 2.5:1.0:1.5.

T) The method of any of paragraphs P-S, wherein the composition further comprises 8% to 20%, by weight of the composition, of a propoxylated and ethoxylated nonionic surfactant comprising an average carbon chain length of 6 to 10.

U) The method of any of paragraphs P-T, wherein the average level of ethoxylation of the ethoxylated and propoxylated nonionic surfactant is 8-9 and the average level of propoxylation is 5-6.

V) The method of any of paragraphs P-U, wherein the ratio by weight of the ethoxylated and propoxylated nonionic surfactant to the dialkyl dimethyl quaternary ammonium salt is from 3:1 to 20:1, preferably 5:1 to 10:1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of potentiating a biocidal impact of a dialkyl dimethyl quaternary ammonium salt, comprising forming a composition by combining about 8% to about 20%, by weight of the composition, of a propoxylated and ethoxylated nonionic surfactant comprising an average carbon chain length of about 6 to about 10, and about 1% to about 3%, by weight of the composition, of the dialkyl dimethyl quaternary ammonium salt, wherein the composition has a higher biocidal impact on Staphylococcus aureus, Klebsiella pneumoniae, Escherichia coli, or any combination thereof, than the sum of the biocidal impact of the dialkyl dimethyl quaternary ammonium salt and the biocidal impact of the nonionic surfactant on the Staphylococcus aureus, Klebsiella pneumoniae, Escherichia coli, or any combination thereof.

2. The method of claim 1, wherein the dialkyl dimethyl quaternary ammonium salt comprises an anion comprising chloride, bromide, acetate, borate, propionate, carbonate, bicarbonate, hydroxide, or a combination thereof.

3. The method of claim 2, wherein the anion comprises bromide or chloride.

4. The method of claim 1, wherein the biocidal impact is measured on Staphylococcus aureus, Klebsiella pneumoniae, or Escherichia coli.

5. The method of claim 1, wherein the dialkyl dimethyl quaternary ammonium salt comprises di-n-decyldimethylammonium chloride, dioctyldimethylammonium chloride, octyl decyl dimethylammonium chloride, di-n-decyldimethylammonium bromide, dioctyldimethylammonium bromide, octyl decyl dimethylammonium bromide, or a combination thereof.

6. The method of claim 1, wherein the ethoxylated and propoxylated surfactant comprises a 2-ethyl hexanol propoxylated ethoxylated surfactant.

7. The method of claim 1, wherein the biocidal impact is measured on a fabric.

8. The method of claim 1, wherein the biocidal impact is measured on a wash water or a rinse water.

9. The method of claim 1, wherein the biocidal impact is measured on a hard surface.

10. The method of claim 1, wherein the composition is substantially free of additional non-ionic surfactants.

11. The method of claim 1, wherein the ratio by weight of the ethoxylated and propoxylated nonionic surfactant to the dialkyl dimethyl quaternary ammonium salt halide is from about 3:1 to about 20:1.

12. The method of claim 1, wherein the average level of ethoxylation of the ethoxylated and propoxylated nonionic surfactant is about 9.

13. The method of claim 1, wherein the average level of propoxylation of the ethoxylated and propoxylated nonionic surfactant is about 4 to about 7.

14. A method of potentiating a biocidal impact of a dialkyl dimethyl quaternary ammonium salt, comprising forming a composition by combining about 3% to about 20%, by weight of the composition, of an amine oxide, and about 1% to about 3%, by weight of the composition, of the dialkyl dimethyl quaternary ammonium salt, wherein the composition has a higher biocidal impact on Staphylococcus aureus than the sum of the biocidal impact of the dialkyl dimethyl quaternary ammonium salt and the biocidal impact of the amine oxide on the Staphylococcus aureus.

15. The method of claim 14, wherein the biocidal impact is measured on a fabric utilizing ASTM E2406.

16. The method of claim 15, wherein the amine oxide is present is an amount of about 5% to about 9% or from about 12% to about 16%, by weight of the composition.

17. The method of claim 16, wherein the dialkyl dimethyl quaternary ammonium salt comprises di-n-decyldimethylammonium chloride, dioctyldimethylammonium chloride, octyl decyl dimethylammonium chloride, di-n-decyldimethylammonium bromide, dioctyldimethylammonium bromide, octyl decyl dimethylammonium bromide, or a combination thereof.

18. The method of claim 15, wherein the composition further comprises about 8% to about 20%, by weight of the composition, of a propoxylated and ethoxylated nonionic surfactant comprising an average carbon chain length of about 6 to about 10.

19. The method of claim 18, wherein the average level of ethoxylation of the ethoxylated and propoxylated nonionic surfactant is about 9 and the average level of propoxylation is about 5.

20. The method of claim 15, wherein the ratio by weight of the ethoxylated and propoxylated nonionic surfactant to the dialkyl dimethyl quaternary ammonium salt is from about 3:1 to about 20:1.
